(19) United States
(12) Patent Application Publication
(10) Pub. No.: US 2003/0185931 A1
(43) Pub. Date: Oct. 2, 2003

(54) Cold runner system for injection molding thermotropic liquid crystal polymer resins

(76) Inventors: Timothy Eric VanAst, Clarkston, MI (US); Paul Richard Chauvin, Cumberland, RI (US)

Correspondence Address: TICONA LLC, 86 MORRIS AVENUE, SUMMIT, NJ, 07901, US

(21) Appl. No.: 10/099,231

(22) Filed: Mar. 14, 2002

(51) Int. Cl. B29C 45/00

(52) U.S. Cl. 425/572; 264/328.8

(57) ABSTRACT

A balanced cold runner system for use in injection molding a thermotropic liquid crystal polymer resin, said runner system comprising a plurality of runners wherein, in the through-plane of resin flow, substantially all the runner sections that connect one runner intersection to the next runner intersection at which branching occurs are free of sharp corners and wherein substantially all of the runner intersections at which a runner branches in no more than two directions are radiused in the direction of resin flow.

### BACKGROUND OF THE INVENTION

1. Field of the Invention

This invention relates to a cold runner system, more particularly, a balanced cold runner system, for injection molding thermotropic liquid crystal polymer resins and, more particularly, high temperature, high flow thermotropic liquid crystal polymer resins.

2. Description of the Prior Art

A variety of runner systems have been proposed for injection molding thermoplastic resins. These runner systems generally fall into one of two categories, hot runner systems or cold runner systems. In hot runner systems the runners are heated, normally by means of an external or internal heating device, to temperatures above the temperature at which the thermoplastic resin solidifies or crystallizes. There is no such runner heating device in cold runner systems, thus, in cold runner systems, the temperature of the runners generally approximates the temperature of the mold, which temperature is below the melting point of the resin.

Hot runner systems tend to be more costly to fabricate and maintain and typically take up more space than cold runner systems, limiting their use in the fabrication of many parts. Additionally, the increased thermal history imparted by hot runner systems may lead to thermal degradation of the thermoplastic resin, which oftentimes is manifested by the appearance of surface blemishes as well as a deterioration of physical properties in the molded parts. Accordingly, cold runner systems are oftentimes the systems of choice for injection molding applications.

In multiple cavity molds, cold runner systems are generally designed to provide a uniform flow of molten resin to the various mold cavities. Runners that provide for a uniform flow of resin to multi-cavity mold are termed “balanced” runners. Typically, balance is achieved by a runner system in which a first or primary runner splits or branches in a symmetrical fashion to provide successive runners that “mirror” the shape and layout of other runners in the same level of branching. A common arrangement of a balanced runner system known as an “H” pattern is illustrated in FIG. 1.

Cold runner systems generally branch out in a linear arrangement of straight runners characterized by sharp 90° angles at the point at which the runners split or turn, giving the runners a “squared” appearance in the through-plane of resin flow, i.e., the plane seen from the top view of the runner system, also termed the horizontal plane of resin flow. In the early history of runner system design, the available fabrication technology relied heavily on machining techniques that lent themselves to the production of squared runner systems. Notwithstanding that fabrication techniques now offer designers and manufacturers greater flexibility, cold runners systems used in injection molding operations involving multiple cavity molds, particularly molds having 4 or more cavities, commonly have a squared appearance in the through-plane of resin flow.

In the case of most thermoplastics, as the molten resin flows through the runner system to the various mold cavities, a leading front of cooler material forms in the melt streams that branch to the various mold cavities. These cold fronts represent regions in the melt where the resin is starting to transition from a liquid to a solid state. Unless removed, the cold fronts can give rise to premature cooling that, in turn, can lead to problems in attaining complete cavity fill, particularly in multi-cavity molds having thin walls or complex designs. The disruption to the flow front caused by premature cooling is often manifested by a mottled appearance, known as “chattering”, in the molded runners and/or parts. Premature cooling may also lead to a deterioration of physical properties in the molded parts.

Means of minimizing the problems associated with premature resin cooling include shortening the path to the mold cavities, increasing molding pressures and melt temperatures, and increasing runner diameters. Owing to space limitations, shortening the path to the mold cavities may not be an option for molds that contain several cavities. Increasing molding pressures and melt temperatures may not be viable when the thermoplastic material has a narrow band of processing conditions and, if not carefully controlled, may result in resin degradation. Increasing runner diameters can add significantly to material costs.

In the case of most thermoplastics, leading cold fronts are commonly removed by means of cold slug wells. Cold slug wells channel the leading fronts of cooler resin away from the path of the flowing resin into a dead zone or “well”. Square or angular runner systems lend themselves to the incorporation of cold slug wells. In such systems, cold slug wells are frequently located directly past the point of intersections formed by runner branching.

The square cold runner systems used with many other thermoplastics have also been used to mold thermotropic liquid crystal polymers. Thermotropic liquid crystal polymers exhibit a parallel ordering of molecular chains in the melt phase and are also termed “anistropic melt-forming polymers”. Unlike many other thermoplastic resins, thermotropic liquid crystal polymers are shear-sensitive materials, meaning that the melt viscosity of the polymers decreases as the shear rate of the polymers is increased. Thermotropic liquid crystal polymers tend to crystallize or solidify more rapidly than many other thermoplastics. Additionally, thermotropic liquid crystal polymers also tend to have heats of fusion that are significantly lower than those of many other thermoplastics. Owing to their processing characteristics, thermotropic liquid crystal polymers tend to have exceptionally fast cycle times; in the case of small parts, the total time from injection to cavity fill is oftentimes less than a second.

The properties of thermotropic liquid crystal polymers lend themselves to the injection molding of thin walled parts and complex design parts such as, for example, electrical connectors, Simm sockets, chip carriers, and the like. However, when used with thermotropic liquid crystal polymers, the linear or square cold runner system designs commonly used with other thermoplastics can give rise to incomplete cavity fill. Attaining complete cavity fill in such systems can be a particular problem when molding a high temperature, high flow thermotropic liquid crystal polymer, i.e., a thermotropic liquid crystal polymer having a melting point or Tₘ (i.e., a solid to nematic endothermic peak as measured by differential scanning calorimetry) of at least 325° C., and a melt viscosity of less than 45 Pascal seconds measured at the normal processing temperature thereof at a shear rate of 1000 sec⁻¹ in a capillary rheometer using an orifice 1 mm in diameter and 20 mm long.

As noted above, thermotropic liquid crystal polymers tend to crystallize faster than many other thermoplastics. Faster crystallizing materials tend to have a less uniform molecular structure than slower crystallizing materials. In the case of thermotropic liquid crystal polymers, for example, a higher degree of molecular orientation is commonly found in the outer “skin” layer of a molded part than in the interior or core of the part. While faster crystallization contributes to faster molding cycles and other processing advantages, when cold runner systems are used to mold faster crystallizing materials like thermotropic liquid crystal polymers, the design of such systems can have a significant effect on the molecular structure and properties of the molded parts. In the case of many thermotropic liquid crystal polymers, particularly high temperature, high flow thermotropic liquid crystal polymers, the use of square runner designs can contribute to non-uniform or premature cooling and can lead to problems of part breakage and warpage, especially in the case of thin walled parts.

While useful with other thermoplastics, many of the techniques conventionally used to minimize the problems of incomplete mold fill and/or premature cooling may be counterproductive in the case of thermotropic liquid crystal polymers. For example, since liquid crystal polymers are shear sensitive, increasing runner diameters tends to reduce “shear” on the polymer melt leading to decreases in melt temperature and increases in melt viscosity. Increasing melt viscosity decreases melt flow which, in turn, can exacerbate problems of incomplete mold fill. Using cold slug wells to remove the leading front of the flowing resin can create a pressure drop that effectively reduces the shear on the polymer melt thereby increasing melt viscosity and decreasing melt flow.

Accordingly, it is an object of this invention to provide a cold runner system that promotes complete cavity fill in the injection molding of thermotropic liquid crystal polymer resins. It is a further object of this invention to provide a cold runner system that is suitable for use in the molding of high temperature, high flow thermotropic liquid crystal polymer resins.

### SUMMARY OF THE INVENTION

In conventional H pattern cold runner systems, in the through-plane of resin flow, molten thermotropic liquid crystal polymer resin flowing around the interior corner of a square bend effectively experiences greater shear and flows faster than resin that is closer to the outer corner of the bend. Owing to the temperature differential between the runner walls and the resin melt, in cold runner systems, the slower moving resin flowing closer to the outer corner of the bend begins to crystallize or solidify, which can give rise to a “dead” spot in the outer corner of the bend and contribute to the problems associated with non-uniform or premature crystallization. Additionally, the sharper interior corner may increase shear degradation in the faster flowing resin, resulting in a more degraded, less “pure” resin entering the mold cavities. The corner effect of square bends and other sharp angles can be amplified in the case of high temperature, high flow thermotropic liquid crystal polymer resins.

It has now been found that giving a radius to the sharp bends of linear or square cold runner systems promotes complete cavity fill in the injection molding of thermotropic liquid crystal polymer resins, particularly high temperature, high flow thermotropic liquid crystal polymer resins. Without wishing to be bound to theory, it is believed that such “curvy” runner systems decrease the likelihood of premature crystallization and reduce the effect of “uncontrollable” shear caused by sharp corners. Additionally, it has been found that runner diameters can, in many instances, be significantly reduced when a curvy runner design is used. Since molded runners are generated in each molding cycle of a cold runner system, over repeated molding cycles, reducing runner size can contribute significantly to reducing the amount of runner waste.

In one embodiment, this invention relates to a balanced cold runner system for use in injection molding a thermotropic liquid crystal polymer resin, said runner system comprising a plurality of runners wherein, in the through-plane of resin flow, substantially all the runners that connect one runner intersection to the next runner intersection at which branching occurs are free of sharp corners and wherein substantially all of the runner intersections at which a runner branches in no more than two directions are radiused in the direction of resin flow. In the context of the described invention, the “substantially all” language allows for the presence of nonconforming runner sections and/or runner intersections, provided, that their presence notwithstanding, the benefits otherwise achieved by eliminating sharp comers and radiusing the runner intersections as described are maintained. It is, however, preferred that all the runner sections that connect one runner intersection to the next runner intersection at which branching occurs are free of sharp comers; similarly, it is preferred that all of the runner intersections at which a runner branches in no more than two directions are radiused in the direction of resin flow.

This invention further relates to a process for molding a thermotropic liquid crystal polymer resin which comprises the steps of:

(a) heating said resin under conditions of elevated temperature and shear to produce a resin melt;

(b) injecting the resin melt to a multi-cavity mold equipped with the runner system of the subject invention;

(c) maintaining the mold in a closed position until such time as the resin melt flows through the runner system, fills the mold cavities, and solidifies sufficiently to allow the molded runners and parts defined by the mold cavities to be ejected from the mold; and

(d) ejecting the molded runners and parts from the mold.

The details and features of the invention are set forth in the description that follows. The attached drawings form part of the specification and are used to illustrate and compare the features of the subject invention to the features found in conventional square runner systems. The drawings are illustrative only.

### BRIEF DESCRIPTION OF THE DRAWINGS

FIG. 1 is a plan view of the layout of a conventional H pattern runner system.

FIG. 2 is a plan view of the layout of a naturally balanced curvy runner system.

FIG. 3 is a plan view of the layout of an unnaturally balanced curvy runner system.

### DETAILED DESCRIPTION OF THE INVENTION

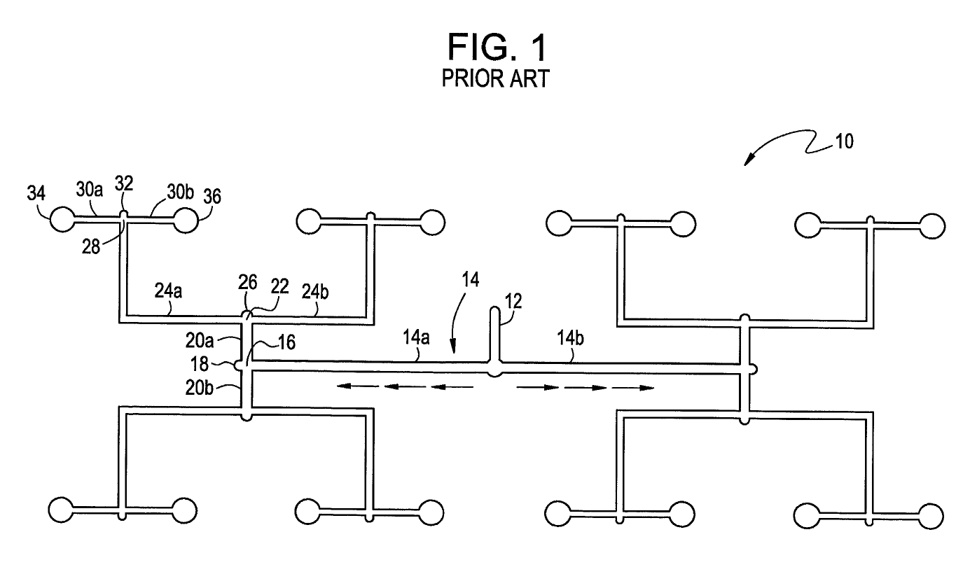

Referring to FIG. 1, which illustrates a plan view of a conventional H pattern runner system 10, molten resin is introduced to the runner system through a runner inlet positioned at injection location 12. From location 12, molten resin travels into a primary runner 14, comprised of sections 14a and 14b in which the resin flows in opposing directions. At runner intersection 16, primary runner section 14a branches into secondary runners 20a and 20b. Primary runner section 14b branches in a similar manner as primary runner section 14a. At runner intersection 22, secondary runner 20a branches into tertiary runners 24a and 24b. Secondary runner 20b branches in a similar manner as secondary runner 20a. At runner intersection 28, tertiary runner 24a branches into final runners 30a and 30b, which connect to their respective mold cavities (not shown) though runner drops 34 and 36. Tertiary runner 24b branches in a similar manner as tertiary runner 24a. Cold slug wells 18, 26, and 32 are located at runner intersections 16, 22, and 28, respectively. The branches and bends illustrated by FIG. 1 all form sharp 90 degree angles. As illustrated, the runner system of FIG. 1 is laid out for a sixteen cavity mold.

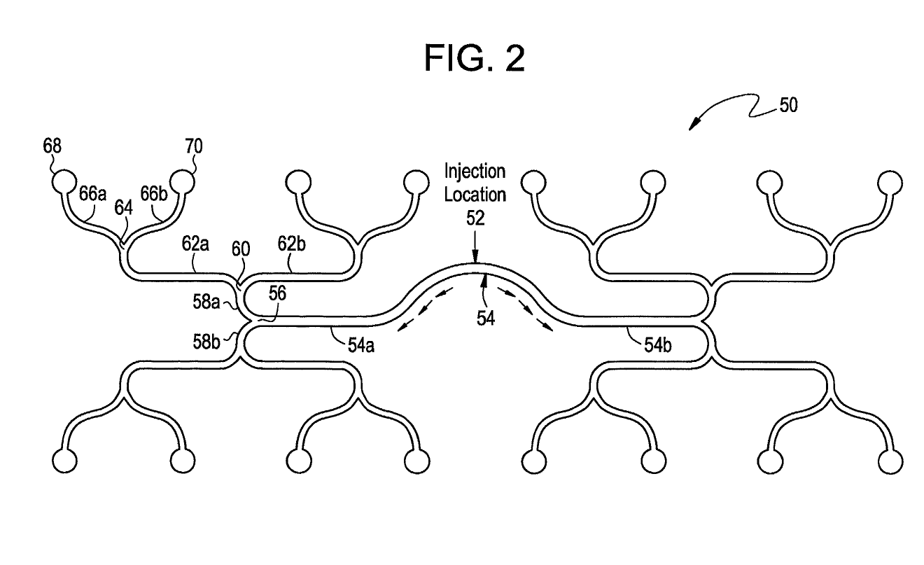

FIG. 2 illustrates a plan view of the layout of a naturally balanced curvy runner system 50 within the scope of the present invention. Molten resin is introduced to the runner system through a runner inlet (not shown) at resin introduction site 52 located at primary runner 54. Primary runner 54 is comprised of sections 54a and 54b, in which the resin flows in opposing directions. At runner intersection 56, primary runner section 54a branches, in a radiused fashion, into secondary runners 58a and 58b. Primary runner section 54b branches in a similar manner as primary runner section 54a. At runner intersection 60, secondary runner 58a branches, in a radiused fashion, into tertiary runners 62a and 62b. Secondary runner 58b branches in a similar manner as secondary runner 58a. At runner intersection 64, tertiary runner 62a branches, in a radiused fashion, into final runners 66a and 66b, which connect to their respective mold cavities (not shown) through runner drops 68 and 70. Tertiary runner 62b branches in a similar manner as tertiary runner 62a. There are no sharp corners in the naturally balanced runner system illustrated by FIG. 2. As illustrated, FIG. 2 is representative of a curvy runner system layout for a sixteen cavity mold; similar layouts can be configured for molds having a different number of naturally balanced cavities.

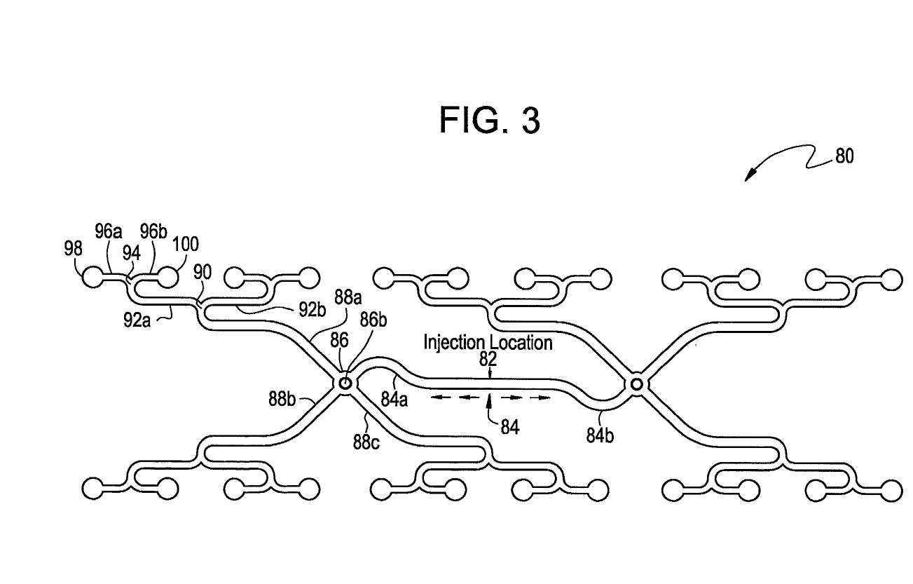

FIG. 3 illustrates a plan view of the layout of an unnaturally balanced curvy runner system 80 within the scope of the present invention. Molten resin is introduced to the runner system through a runner inlet (not shown) at resin introduction site 82 located at primary runner 84. Primary runner 84 is comprised of sections 84a and 84b in which the resin flows in opposing directions. At runner intersection 86, primary runner section 84a branches into secondary runners 88a, 88b, and 88c. Runner intersection 86 is equipped with a sucker pin 86b; the circular configuration of intersection 86 helps to even out flow to each of the secondary runners branching therefrom. Primary runner section 84b branches in a similar manner as primary runner section 84a. At runner intersection 90, secondary runner 88a branches, in a radiused fashion, into tertiary runners 92a and 92b. Secondary runners 88b and 88c branch in a similar manner as secondary runner 88a. At runner intersection 94, tertiary runner 92a branches, in a radiused fashion, into final runners 96a and 96b, which connect to their respective mold cavities (not shown) through runner drops 98 and 100. Tertiary runner 92b branches in a similar manner as tertiary runner 92a. Although a portion of each of runners 88a, 88b, and 88c is straight, the bend in each runner is curved. There are no sharp corners in the unnaturally balanced runner system illustrated by FIG. 3. As illustrated, FIG. 3 is representative of a curvy runner system layout for a twenty-four cavity mold; similar layouts can be configured for molds having a different number of cavities.

Balanced runner systems are systems that deliver resin to the various mold cavities such that resin flows into the cavities at substantially the same time and at substantially the same rate of flow. The runner system of the present invention can be used for naturally balanced systems, i.e., systems wherein the number of mold cavities can be expressed as a power of two, e.g. 4, 8, 16, 32, etc., as well as other balanced systems having an odd or even number of mold cavities, e.g., 6, 9, 12, 24, etc., i.e., unnaturally balanced systems. The runner system is particularly well suited for use in molds having at least 4 mold cavities, with runner systems for use in molds having at least 16 mold cavities being of particular interest.

In an embodiment of particular interest, this invention relates to a balanced cold runner system for use in injection molding a thermotropic liquid crystal polymer, said system comprising a plurality of runners wherein, in the through-plane of resin flow, the system is free of sharp corners and wherein (a) the runner intersections at which a runner branches in more than two directions have a circular junction configured to deliver resin into the runners formed by such branching at a substantially equal rate and (b) the runner intersections at which a runner branches in no more than two directions are radiused. Where a runner branches in three directions, providing the intersection with a circular junction that encircles a sucker pin or similar feature promotes even distribution of resin into the resulting branches. See, for example, runner intersection 86 in FIG. 3. At runner intersections where a runner branches in only two opposing directions, even distribution can be accomplished by radiusing the intersection in the direction of resin flow. See, for example, runner intersections 90 and 94 of FIG. 3.

In another embodiment of particular interest, this invention relates to a balanced cold runner system for use in injection molding thermotropic liquid crystal polymer resin wherein said cold runner system comprises a primary runner, which primary runner branches in at least two directions thereby forming secondary runners, which secondary runners optionally continue to branch in at least two directions thereby forming additional orders of runners, wherein each runner in the final order of runners connects, either directly or through a runner drop, to its own mold cavity, and wherein in the through-plane of resin flow (a) each of the runners of higher order than the primary runner order and lower order than the runners of in the final order of runners is other than straight, and (b) wherein none of the runners contains sharp corners. As used in the subject specification, the primary runner is the lowest order runner in the system; it is generally has the largest cross section of the various runners that comprise the runner system. The primary runner should not be confused with and does not include mold inlet channels or drops that introduce material to the runner system.

Desirably, the runner system is substantially free of cold slug wells that are positioned in a manner so as to reduce the shear on the polymer melt moving through the runner. Since cold slug wells often serve as an engagement site for sucker pins, they may be a desired element of the runner system. If they are to be included, it is recommended that they be included at positions where they do not give rise to undesirable pressure drops such as, for example, points above or beyond runner drops. If they are to be included at positions where they give rise to pressure drops in the resin flowing through the runners, it is recommended that their use be minimized so as not to defeat the objectives of this invention. Runner intersections should also be configured to minimize or avoid pressure drops.

While full round, half round, or modified trapezoid cross sections are among the various runner cross sections that may be employed in the practice of this invention, the runners preferably have full round or modified trapezoid cross sections. In many applications the use of runners having a modified trapezoid cross section is of particular interest. By “modified trapezoid” what is meant is trapezoid with a full round radius at its bottom; desirably the modified trapezoid has a depth equal to approximately twice the radius, and at least 5°, preferably 5° to 10° angle sides.

Desirably the runners should step down in size after each branch to maintain a substantially constant cross-sectional area in the runner system. Steps should be transitioned smoothly so that no sharp steps are taken; preferably, this is accomplished by tapering down the runner diameter within a radial section of runner at a point beyond the runner intersection.

The runner system can be fabricated from materials that include hardened tool steel. To improve melt flow, preferably the runner system is highly polished and free of cutter marks.

The subject invention allows runner system designers to substantially reduce the size of runners and runner drops, leading to savings in raw material costs and minimizing the waste to be consumed as regrind. While the overall size of the runners and runner drops depends, in part, on the size and number of mold cavities, it is often possible to achieve runner diameters within a range of about 0.03 inch to about 0.1 inch. By replacing conventional square runner systems with the runner systems of this invention, it is often possible to reduce the amount of runner waste by a minimum of 20%.

Representative classes of the thermotropic liquid crystal polymers which can be used in the subject invention include wholly aromatic polyesters, aromatic-aliphatic polyesters, wholly aromatic poly(ester-amides), and aromatic-aliphatic poly(ester-amides). In such wholly aromatic polyester and wholly aromatic poly(ester-amides), each moiety present within the polymer chain contributes at least one aromatic ring, Wholly aromatic polyesters that include naphthalene moieties, preferably 6-oxy-2-naphthoyl moieties, and p-oxy-benzoyl moieties are of particular interest, as are wholly aromatic polyesters that include 6-oxy-2-naphthoyl moieties, p-oxy-benzoyl moieties aromatic diacid moieties such as terephthaloyl moieties or a combination of terephthaloyl and isophthtaloyl moities and a balancing amount of aromatic diol moities such as moieties derived from 4,4′-biphenol, hydroquinone, resorcinol, 2,6-naphthalene diol, or combinations are of particular interest. Representative wholly aromatic and aromatic-aliphatic thermotropic liquid crystal polymers include those disclosed in the following U.S. patents which are herein incorporated by reference: U.S. Pat. Nos. 4,067,852; 4,083,829; 4,130,545; 4,153,779; 4,156,070; 4,159,365; 4,161,470; 4,184,996; 4,201,856; 4,219,461; 4,256,624; 4,269,965; 4,294,955; 4,318,841; 4,337,190; 4,337, 191; 4,355,134; 4,473,682; 4,522,974; 4,746,694; 4,849,499; 4,920,197; 5,066,767; 5,089,594; 5,110,896; 5,115,080; 5,171,823; 5,179,192; 5,221,729; 5,221,730; 5,237,038; 5,250,654; 5,260,409; 5,397,502; 5,466,773; 5,525,700; 5,710,237; and 6,022,491.

Other representative aromatic-aliphatic thermotropic liquid crystal polyesters are copolymers of polyethylene terephthalate and hydroxybenzoic acid as disclosed in Polyester X-7G-A Self-Reinforced Thermoplastic, by W. J. Jackson, Jr., H. F. Kuhfuss, and T. F. Gray, Jr., 30^{th} Anniversary Technical Conference, 1975 Reinforced Plastics/Composites Institute, The Society of the Plastics Industry, Inc., Section 17-D, Pages 1-4. A further disclosure of such copolymers can be found in “Liquid Crystal Polymers: I Preparation and Properties of p-Hydroxybenzoic Acid Copolymers,” Journal of Polymer Science, Polymer Chemistry Edition, Vol. 14, pages 2043 to 2058 (1976), by W. J. Jackson, Jr., and H. F. Kuhfuss. Aromatic-aliphatic liquid crystal polymers are also disclosed in U.S. Pat. Nos. 4,318,842 and 4,355,133, which are herein incorporated by reference.

Representative wholly aromatic and aromatic-aliphatic poly(ester-amides) which exhibit thermotropic liquid crystalline properties are disclosed in U.S. Pat. Nos. 4,330,457; 4,339,375; 4,351,917; 4,351,918; 4,355,132; 4,339,375; 5,204,443; and 5,688,895 which are herein incorporated by reference.

The thermotropic liquid crystal polymers used herein preferably have an inherent viscosity of at least about 2.0 dl/g, measured at 25° C. as a 0.1 percent by weight solution in 50:50 (v:v) hexafluoroisopropanol/pentafluorophenol. Depending upon the particular polymers, processing temperatures typically range from about 270° C. to about 360° C., or higher. As discussed above, the runner system of the subject invention is particularly well suited for use with high temperature, high flow thermotropic liquid crystal polymers.

One or more solid fillers and/or reinforcing agents may be optionally incorporated in thermotropic liquid crystal polymer resins of the subject invention. When present, such fillers or reinforcing agents are typically included in amounts up to about 50 weight percent based on the total weight of the composition. Other optional components include colorants, lubricants, processing aids, stabilizers and the like.

Thermotropic liquid crystal polymer resins suitable for use herein are commercially available from a number of sources and include liquid crystal polymer resins available from Ticona, the engineering resins business of Celanese AG, under the trademark VECTRA®. Thermotropic liquid crystal polymer resins suitable for use in the subject invention are also available from DuPont, Eastman, and Solvay. The Ei and H grades of VECTRA® liquid crystal polymers are representative of high temperature, high flow resins.

What is claimed is:

1. A balanced cold runner system for use in injection molding a thermotropic liquid crystal polymer resin, said runner system comprising a plurality of runners wherein, in the through-plane of resin flow, substantially all the runners that connect one runner intersection to the next runner intersection at which branching occurs are free of sharp corners and wherein substantially all of the runner intersections at which a runner branches in no more than two directions are radiused in the direction of resin flow.

2. A balanced cold runner system as described in claim 1 wherein the runner system is substantially free of cold slug wells positioned to reduce the shear on the resin as it flows through the runners.

3. A balanced cold runner system as described in claim 1 wherein the runners have a cross section selected from the group consisting of round and modified trapezoid cross sections.

4. A balanced cold runner system as described in claim 1 wherein the runners have diameters of from about 0.03 inch to about 0.1 inch.

5. A balanced cold runner system as described in claim 1 wherein the runner system is used in a multi-cavity mold that contains at least 16 mold cavities.

6. A balanced cold runner system as described in claim 1 wherein the thermotropic liquid crystal polymer resin comprises a high temperature, high flow thermotropic liquid crystal polymer.

7. A balanced cold runner system as described in claim 1 wherein the runner system is naturally balanced.

8. A balanced cold runner system as described in claim 1 wherein the runner system is unnaturally balanced.

9. A balanced cold runner system for use in injection molding a thermotropic liquid crystal polymer resin, said runner system comprising a plurality of runners wherein, in the through-plane of resin flow, the system is free of sharp corners and wherein (a) the runner intersections at which a runner branches in more than two directions have a circular junction configured to deliver resin into the runners formed by such branching at a substantially equal rate and (b) the runner intersections at which a runner branches in no more than two directions are radiused.

10. A balanced cold runner system as described in claim 9 wherein the runner system is substantially free of cold slug wells positioned to reduce the shear on the resin as it flows through the runner branches.

11. A balanced cold runner system as described in claim 9 wherein the runner sections have a cross section selected from the group consisting of round and modified trapezoid cross sections.

12. A balanced cold runner system as described in claim 11 which is unnaturally balanced.

13. A balanced cold runner system for use in injection molding thermotropic liquid crystal polymer resin wherein said cold runner system comprises a primary runner, which primary runner branches in at least two directions thereby forming secondary runners, which secondary runners optionally continue to branch in at least two directions thereby forming additional orders of runners, wherein each runner in the final order of runners connects, either directly or through a runner drop, to its own mold cavity, and wherein in the through-plane of resin flow (a) each of the runners of higher order than the primary runner order and lower order than the runners of in the final order of runners is other than straight, and (b) wherein none of the runners contains sharp corners

14. A balanced cold runner system as described in claim 13 wherein the runner system is substantially free of cold slug wells positioned to reduce the shear on the thermotropic liquid crystal polymer resin as it flows through the runners.

15. A balanced cold runner system as described in claim 13 wherein the runners have a modified trapezoid cross section.

16. A balanced cold runner system as described in claim 15 wherein the runners step down in size after each branch to maintain a substantially constant cross-sectional area in the runner system.

17. A process for molding a resin comprising a thermotropic liquid crystal polymer resin which comprises the steps of:
(a) heating said resin under conditions of elevated temperature and shear to produce a resin melt;
(b) injecting the resin melt to a multi-cavity mold equipped with a cold runner system comprising a plurality of runners wherein, in the through-plane of resin flow, substantially all the runners that connect one runner intersection to the next runner intersection at which branching occurs are free of sharp corners and wherein substantially all of the runner intersections at which a runner branches in no more than two directions are radiused in the direction of resin flow;
(c) maintaining the mold in a closed position until such time as the resin melt flows through the runner system, fills the mold cavities, and solidifies sufficiently to allow the molded runners and parts defined by the mold cavities to be ejected from the mold; and
(d) ejecting the molded runners and parts from the mold.

18. A process as defined in claim 17 wherein said resin comprises a high temperature, high flow thermotropic liquid crystal polymer.

19. A process as defined in claim 18 wherein said mold has at least 16 mold cavities.
